(19) United States
(12) Patent Application Publication
(10) Pub. No.: US 2006/0011476 A1
(43) Pub. Date: Jan. 19, 2006

(54) Gas concentration measuring apparatus designed to ensuring accuracy of determining resistance of gas sensor element

(75) Inventors: Satoshi Hada, Inazawa-shi (JP); Mitsunobu Niwa, Kariya-shi (JP); Toshiyuki Suzuki, Handa-shi (JP); Eiichi Kurokawa, Okazaki-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/181,854

(22) Filed: Jul. 15, 2005

(30) Foreign Application Priority Data
Jul. 16, 2004 (JP) 2004-209871
Sep. 7, 2004 (JP) 2004-259766
May 9, 2005 (JP) 2005-135632

(51) Int. Cl. G01N 27/26

(52) U.S. Cl. 204/406; 204/426

(57) ABSTRACT

A gas concentration measuring apparatus is provided which works to measure the concentration of a gas using a gas sensor element. The apparatus also works to determine the impedance of the gas sensor element through an arithmetic circuit for use in controlling the activation or diagnosis of the gas sensor element. The arithmetic circuit uses a command signal from a sensor controller to determine a sampling time at which a change in voltage applied to the sensor element or current flowing therethrough that is a function of the impedance of the sensor element is to be sampled. This permits the impedance to be calculated accurately in a simplified manner without use of a resource such as a timer.

### CROSS REFERENCE TO RELATED DOCUMENT

The present application claims the benefits of Japanese Patent Application No. 2005-135632 filed on May 9, 2005, No. 2004-209871 filed on Jul. 16, 2004, and No. 2004-259766 filed on Sep. 7, 2004, the disclosures of which are incorporated herein by reference.

### BACKGROUND OF THE INVENTION

1. Technical Field of the Invention

The present invention relates generally to a gas concentration measuring apparatus which may be used in measuring the concentration of a preselected gas component of exhaust emissions of automotive engines, and more particularly to such a gas concentration measuring apparatus designed to ensuring the accuracy of determining the resistance of a gas sensor element in a simplified manner for use in controlling activation or diagnosis of the gas sensor element, for example.

2. Background Art

Limiting current air-fuel (A/F) ratio sensors (also called A/F sensors) are known which measure the concentration of oxygen (O₂) contained in exhaust emissions of motor vehicle engines to determine an air-fuel ratio of a mixture supplied to the engine. A typical one of the A/F sensors includes a sensor element made up of a solid electrolyte body and a pair of electrodes affixed to the solid electrolyte body. The measurement of concentration of oxygen is achieved by applying the voltage to the solid electrolyte body through the electrodes to produce a flow of electrical current through the sensor element as a function of the concentration of oxygen and sampling the electrical current for determining the air-fuel ratio of the mixture.

Ensuring the accuracy of measuring the concentration of oxygen requires keeping the sensor element activated completely. The degree of such activation is usually found by measuring the resistance (i.e., impedance) of the sensor element. The measurement of the resistance of the sensor element is achieved by sweeping the level of voltage applied to the sensor element through a sensor circuit to a positive or negative side, measuring a change in the voltage applied to the sensor element, and sampling a resulting change in current flowing through the sensor element that is a function of the resistance of the sensor element. For example, Japanese Patent First Publication Nos. 9-292364 (U.S. Pat. No. 6,084,418 issued on Jul. 4, 2000) and 2000-81414 teach how to determine the resistance of the sensor element.

The resistance of the sensor element determined is used to control a heater for activating the sensor element or failure diagnosis thereof. In recent years, emission control regulations or sensor diagnosis regulations have been tightened. The improvement on the accuracy in determining the resistance of the sensor element is, therefore, sought. The measurement of the resistance of the sensor element, as described above, requires measurement of an actual value of the voltage applied to the sensor element in terms of an individual variability of the system. If an error in such measurement arises, it will result in decreased accuracy of determination of the resistance of the sensor element. The improvement on techniques for determining the resistance is, thus, sought. Additionally, simplification of the structure of the system is also sought.

### SUMMARY OF THE INVENTION

It is therefore a principal object of the invention to avoid the disadvantages of the prior art.

It is another object of the invention to provide a gas concentration measuring apparatus designed to ensure the accuracy of determining the resistance of a sensor element in a simplified manner.

According to one aspect of the invention, there is provided a gas concentration measuring apparatus which may be employed in determining an air-fuel ratio of a mixture supplied to an automotive engine for use in combustion control of the engine. The gas concentration measuring apparatus comprises: (a) a sensor circuit connected to a gas sensor element equipped with a solid electrolyte, the sensor circuit working to measure an output of the gas sensor element produced as a function of concentration of a gas and output a signal indicative of the measured output; and (b) an arithmetic circuit working to analyze the signal outputted from the sensor circuit to determine a concentration of the gas. The arithmetic circuit outputs a first command signal cyclically. The sensor circuit is responsive to an input of the first command signal from the sensor circuit to output a second command signal for a given period of time and to subject the gas sensor element to a given amount of change in one of voltage applied thereto and current flowing therethrough. The sensor circuit measures and retains a resulting change in one of current flowing through the gas sensor element and voltage developed at the gas sensor element. The arithmetic circuit is responsive to input of the second command signal from the sensor circuit to determine a sampling time. When the sampling time is reached, the arithmetic circuit starts to sample the resulting change out of the sensor circuit and calculating a resistance of the gas sensor element based on the sampled resulting change. Specifically, using the second command signal, the arithmetic circuit determines the sampling time at which the resulting change is to be sampled, thus eliminating the need for a timer to specify the sampling time. This results in decreases in resource and operational load of the arithmetic circuit.

In the preferred mode of the invention, the second command signal outputted by the sensor circuit works as an inhibit signal to inhibit the arithmetic circuit from analyzing the signal outputted from the sensor circuit to determine the concentration of the gas for the given period of time.

The inhibit signal is switchable between an inhibit level to inhibit determination of the concentration of the gas and an enable level to permit the determination of the concentration of the gas. Upon switching of the inhibit signal from the inhibit level to the enable level, the arithmetic circuit starts to sample the resulting change out of the sensor circuit.

The second command signal may be made up of a set of pulses. The arithmetic circuit may determine the sampling time based on input of one of the pulses.

According to the second aspect of the invention, there is provided a gas concentration measuring apparatus which comprises: (a) a sensor circuit designed to apply a voltage to a gas sensor element equipped with a solid electrolyte and measure a resulting flow of current through the gas sensor element to determine a concentration of a gas based on the measured current, when a resistance measuring mode is entered, the sensor circuit working to create a change in one of voltage and current in an electric line leading to the gas sensor element and sample a resulting change in one of current flowing through the gas sensor element and voltage developed at the gas sensor element; and (b) an arithmetic circuit working to use only the sampled resulting change in the one of current and voltage as a variable parameter to determine a resistance of the gas sensor element. This eliminates the need for measuring an actual amount of the change in one of voltage and current created in the electric line leading to the gas sensor element, thus eliminating any error in calculating the resistance of the gas sensor element arising from an error in measuring the change in one of voltage and current.

In the preferred mode of the invention, the arithmetic circuit stores the change in one of voltage and current to be created in the electric line leading to the gas sensor element as a fixed value and determines the resistance of the gas sensor element based on the fixed value and the sampled resulting change in the one of current and voltage.

The sensor circuit may also work to amplitude the sampled resulting change in the one of current and voltage to produce a sensor response signal. The arithmetic circuit is implemented by a microcomputer which works to A/D convert the sensor response signal to determine the resistance of the gas sensor element.

The sensor circuit may include a circuit component working to subject the gas sensor element to the given amount of change in one of voltage applied thereto and current flowing therethrough. The circuit component is trimmed to adjust an electric characteristic thereof so as to bring the given amount of change in the one of voltage and current into agreement with a desired one.

According to the third aspect of the invention, there is provided a gas concentration measuring apparatus which comprises: (a) a gas sensor element equipped with a pair of electrodes and a solid electrolyte interposed between the electrodes, the gas sensor element working to produce an electromotive force as a function of concentration of one of oxygen contained in gases and a specified component of the gases which contains an oxygen component; (b) an electric change creating circuit working to create a change in one of voltage and current in an electric line leading to the gas sensor element; (c) a series circuit made up of a resistor and a capacitor joined in series, the series circuit being connected between the electric change creating circuit and the gas sensor element; (d) a voltage measuring circuit working to measure a voltage developed at a terminal of the gas sensor element; and (e) an arithmetic circuit working to use only a value of the voltage measured by the voltage measuring circuit which results from the change in the one of voltage and current created by the electric change creating circuit as a variable parameter to determine a resistance of the gas sensor element.

In the preferred mode of the invention, the arithmetic circuit stores the change in one of voltage and current to be created in the electric line leading to the gas sensor element as a fixed value and determines the resistance of the gas sensor element based on the fixed value and the measured value of the voltage.

The voltage measuring circuit may also work to amplitude and output the voltage developed at the terminal of the gas sensor element as a sensor response signal. The arithmetic circuit is implemented by a microcomputer which works to A/D convert the sensor response signal to determine the resistance of the gas sensor element.

The electric change creating circuit is trimmed to adjust an electric characteristic thereof so as to bring the change in the one of voltage and current to be created into agreement with a desired one.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a circuit diagram which shows an electric structure of a gas concentration measuring apparatus according to the first embodiment of the invention;

FIG. 2 is a transverse sectional view which shows a sensor element used in the gas concentration measuring apparatus as illustrated in FIG. 1;

FIG. 3 shows an example of an applied voltage-to-output current map for use in determining a target voltage to be applied to the sensor element as illustrated in FIG. 2;

FIG. 4 is a timechart which demonstrates a time-sequential relation among an impedance measuring command signal SG1, an air-fuel ratio determination enable/inhibit signal SG4, a voltage switching signal SG2, a gate command signal SG3, a voltage applied to a sensor element, and a current change signal Iout;

FIG. 5 is a circuit diagram which shows an electric structure of a gas concentration measuring apparatus according to the second embodiment of the invention;

FIG. 6 is a flowchart of a program to determine a sensor element impedance;

FIG. 7 is a circuit diagram which shows an electric structure of a gas concentration measuring apparatus according to the third embodiment of the invention;

FIG. 8 is a circuit diagram which shows an electric structure of a gas concentration measuring apparatus according to the fourth embodiment of the invention;

FIG. 9 is a circuit diagram which shows a modification of a sensor control circuit as illustrated in FIG. 5;

FIG. 10 is a transverse sectional view which shows a first modification of a sensor element which may be employed in a gas concentration measuring apparatus of each embodiment; and

FIG. 11 is a transverse sectional view which shows a second modification of a sensor element which may be employed in a gas concentration measuring apparatus of each embodiment.

### DESCRIPTION OF THE PREFERRED EMBODIMENTS

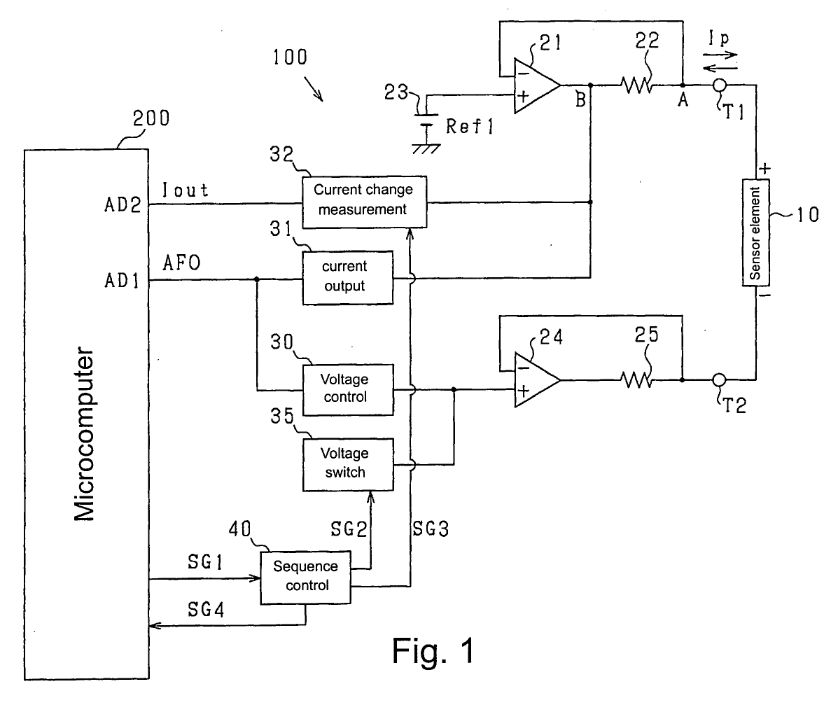

Referring to the drawings, wherein like reference numbers refer to like parts in several views, particularly to FIG. 1, there is shown a gas concentration measuring apparatus designed to measure the concentration of oxygen (O₂) contained in exhaust emissions of an automotive engine which corresponds to an air-fuel ratio (AFR) of a mixture supplied to the engine. The measured concentration is used in an air-fuel ratio control system implemented by an engine electronic control unit (ECU). The air-fuel ratio control system works to perform a stoichiometric burning control to regulate the air-fuel ratio of the mixture around the stoichiometric air-fuel ratio under feedback control and a lean-burn control to bring the air-fuel ratio to within a given lean range under feedback control.

The gas concentration measuring apparatus generally includes a sensor control circuit 100 and an oxygen sensor. The oxygen sensor is the so-called air-fuel ratio (A/F) sensor which works to produce a current signal as a function of concentration of oxygen contained in exhaust emissions introduced into a gas chamber formed in the A/F sensor.

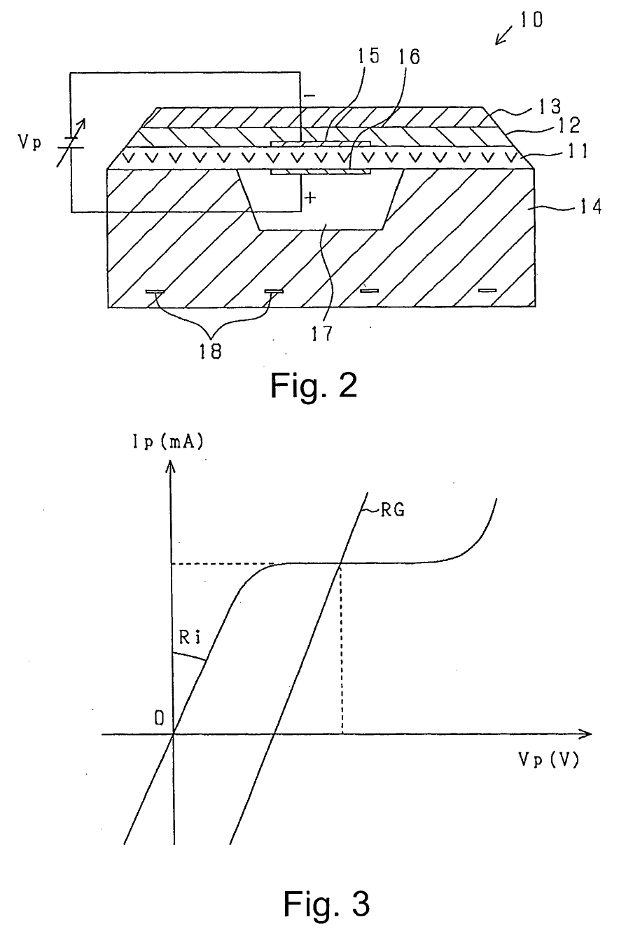

The A/F sensor includes a laminated sensor element 10 which has a sectional structure, as illustrated in FIG. 2. The sensor element 10 has a length extending perpendicular to the drawing surface of FIG. 2 and is, in practice, disposed within an assembly of a sensor housing and a protective cover. The A/F sensor is installed in an exhaust pipe of the engine. For instance, EPO 987 546 A2, assigned to the same assignee as that of this application teaches a structure and control of an operation of this type of gas sensor in detail, disclosure of which is incorporated herein by reference.

The sensor element 10 is made up of a solid electrolyte layer 11, a diffusion resistance layer 12, a shielding layer 13, and an insulating layer 14 which are laminated or stacked vertically as viewed in the drawing. The sensor element 10 is surrounded by a protective layer (not shown). The solid electrolyte layer 11 is made of a rectangular partially-stabilized zirconia sheet and has upper and lower electrodes 15 and 16 affixed to opposed surfaces thereof. The electrodes 15 and 16 are made of platinum (Pt), for example. The diffusion resistance layer 12 is made of a porous sheet which permits the exhaust gasses to penetrate therethrough to the electrode 15. The shielding layer 13 is made of a dense sheet which inhibits the exhaust gasses from passing therethrough. The layers 12 and 13 are each formed using a sheet made of ceramic such as alumina or zirconia and have average porosities, or gas permeability different from each other.

The insulating layer 14 is made of ceramic such as alumina or zirconia and has formed therein an air duct 17 to which the electrode 16 is exposed. The insulating layer 14 has a heater 18 embedded therein. The heater 18 is made of heating wire which is supplied with power from a storage battery installed in the vehicle to heat the whole of the sensor element 10 up to a desired activation temperature. The heater 18 may alternatively be affixed to the outer wall of the sensor element 10. In the following discussion, the electrode 15 will also be referred to as a diffusion resistance layer side electrode, and the electrode 16 will also be referred to as an atmosphere side electrode. The atmosphere side electrode 16 is connected to a positive (+) terminal of a power source, while the diffusion resistance layer side electrode 15 is connected to a negative (−) terminal of the power source.

The exhaust gasses flowing within an exhaust pipe of the engine to which the sensor element 10 is exposed enter and pass through the side of the diffusion resistance layer 12 and reach the diffusion resistance layer side electrode 15. When the exhaust gasses are in a fuel lean state (more oxygen), oxygen molecules contained in the exhaust gasses are decomposed or ionized by application of voltage between the electrodes 15 and 16, so that they are discharged to the air duct 17 through the solid electrolyte layer 11 and the electrode 16. This will cause a positive current to flow from the atmosphere side electrode 16 to the diffusion resistance layer side electrode 15. Alternatively, when the exhaust gasses are in a fuel rich state (less oxygen), oxygen molecules contained in air within the air duct 17 are ionized by the electrode 16 so that they are discharged into the exhaust pipe through the solid electrolyte layer 11 and the electrode 15 and undergo catalytic reaction with unburned components such as HC or CO in the exhaust gasses. This will cause a negative current to flow from the diffusion resistance layer side electrode 15 to the atmosphere side electrode 16. The operation of the A/F sensor is well known in the art, and explanation thereof in detail will be omitted here.

FIG. 3 shows a typical voltage-to-current relation (i.e., V-I characteristic) of the A/F sensor. A straight segment of a V-I curve extending parallel to the abscissa axis (i.e., V-axis) indicates a limiting current range within which the sensor element 10 produces an electric current Ip (i.e., a limiting current) as a function of an air-fuel ratio (i.e., richness or leanness). Specifically, as the air-fuel ratio changes to the lean side, the current Ip produced by the sensor element 10 increases, while as the air-fuel ratio changes to the rich side, the current Ip decreases. The current Ip will also be referred to as a sensor element current below.

A portion of the V-I curve lower in voltage than the limiting current range represents a resistance-dependent range. An inclination of a first-order segment of the V-I curve depends upon dc internal resistance Ri of the sensor element 10. The dc internal resistance Ri changes with a change in temperature of the sensor element 10. Specifically, it increases with a decrease in temperature of the sensor element 10, so that the inclination of the first-order segment of the V-I curve in the resistance-dependent range is decreased. Alternatively, when the temperature of the sensor element 10 rises, it results in a decrease in the dc internal resistance Ri, so that the inclination of the first-order segment of V-I curve is increased. A line RG indicates a target voltage Vp to be applied to the sensor element 10 (i.e., the electrodes 15 and 16).

Referring back to FIG. 1, the gas concentration measuring apparatus includes the microcomputer 200 and the sensor control circuit 100. The sensor control circuit 100 connects with the sensor element 10 through a positive (+) terminal T1 and a negative (−) terminal T2. The positive terminal T1 leads to the atmosphere side electrode 16 of the sensor element 10, while the negative terminal leads T2 to the diffusion resistance layer side electrode 15. The sensor control circuit 100 also includes operational amplifiers 21 and 24, a current-measuring resistor 22, a reference voltage source 23, a resistor 25, a voltage application control circuit 30, a sensor element current output circuit 31, a current change measuring circuit 32, a voltage switching circuit 35, and a sequence controller 40.

The operational amplifier 21 and the current-measuring resistor 22 connect with the positive terminal T1. The voltage application control circuit 30 connects with the negative terminal T2 through the operational amplifier 24 and the resistor 25. The voltage appearing at a junction A of an end of the current-measuring resistor 22 and the positive terminal T1 of the sensor element 10 is kept at the same level as a reference voltage Vref1, as developed by the reference voltage source 23. The sensor element current Ip flows through the current-measuring resistor 22. The voltage appearing at a junction B changes with a change in the sensor element current Ip. When the exhaust gas of the engine is in a fuel lean state, that is, the exhaust gas arises from burning of a lean mixture, the sensor element current Ip flows from the positive terminal T1 to the negative terminal T2 through the sensor element 10, so that the voltage at the junction B rises. Conversely, when the exhaust gas is a fuel rich state, the sensor element current Ip flows from the negative terminal T2 to the positive terminal T1 through the sensor element 10, so that the voltage at the junction B drops. The sensor element current measuring circuit 31 monitors the voltage at the junction B and outputs it as an A/F output voltage AFO to the microcomputer 200. The sensor element current measuring circuit 31 is implemented by, for example, a sample-and-hold (S/H) circuit which works to sample the voltage at the junction B in an air-fuel ratio measuring mode and update and output it, in sequence, during a preselected gate turn-on time. The microcomputer 200 receives the A/F output voltage AFO through an A/D (analog-to-digital) port AD1 and calculates an instantaneous value of the air-fuel ratio of a mixture to the engine as a function of the A/F output voltage AFO for use in the air-fuel ratio feedback control.

The voltage application control circuit 30 works to monitor the A/F output voltage AFO (i.e., a sampled and held value of the voltage at the junction B) and determine the target voltage Vp to be applied to the sensor element 10 as a function of the monitored voltage AFO, for example, by look-up using the target applying voltage line RG, as illustrated in FIG. 3. Specifically, the voltage application control circuit 30 increases the voltage to be applied to the sensor element 10 when the sensor element current Ip is increasing, that is, when the voltage at the junction B is rising. The voltage application control circuit 30 may alternatively be designed to keep the voltage to be applied to the sensor element 10 at a constant level.

The microcomputer 200 also works to sweep the voltage applied to the sensor element 10 instantaneously in an ac form to determine the sensor element impedance Zac (i.e., an internal resistance of the sensor element 10) using a resulting change in the current Ip flowing through the sensor element 10. Specifically, the microcomputer 200 interrupts the air-fuel ratio measuring mode and enters an impedance measuring mode cyclically to change the voltage applied to the sensor element 10 for measuring the air-fuel ratio (i.e., the voltage controlled by the voltage application control circuit 30) to one for measuring the sensor element impedance Zac. In the impedance measuring mode, the microcomputer 20 changes the level of an impedance measuring command signal SG1 outputted to the sequence controller 40 at an interval of, for example, 128 msec. to produce a trigger for initiating measurement of the sensor element impedance Zac. The sequence controller 40 is responsive to such a trigger to change the level of a voltage switching signal SG2 outputted to the voltage switching circuit 35. The voltage switching circuit 35 is responsive to such a change in the level of the voltage switching signal SG2 to sweep the level of the voltage to be applied to the sensor element 10 in the ac form. For example, the voltage switching circuit 35 changes the voltage applied to the sensor element 10 at 1 kHz to 20 kHz by a given level (e.g., 0.2V) to the positive or negative side. This causes the sensor element current Ip flowing through the sensor element 10 to change, thus resulting in a change in voltage developed at the junction B.

The current change measuring circuit 32 measures the voltage at the junction B and outputs it as a current change signal Iout to the microcomputer 200. The current change measuring circuit 32 is made up of, for example, a high-pass filter (HPF) and a peak-and-hold (P/H) circuit which are connected in series. The P/H circuit works to hold the value of voltage (i.e., a current peak) as developed at the junction B during the preselected gate turn-on time. The gate turn-on time is determined by a gate command signal SG3 outputted by the sequence controller 40. The current peak is reset every start of the gate turn-on time.

The voltage application control circuit 30, the sensor element current output circuit 31, the current change measuring circuit 32, the voltage switching circuit 35, and the sequence controller 40 may be made of a single IC.

The microcomputer 200 receives the current change signal Iout outputted from the current change measuring circuit 32 through an A/D port AD2 and calculates a change ΔI in the sensor element current Ip in the impedance measuring mode. The microcomputer 200 determines the sensor element impedance Zac based on a change A Vin voltage applied to the sensor element 10 and the current change ΔI (i.e., Zac=ΔV/ΔI). The microcomputer 200 also works to control the amount of current supplied to the heater 18 so as to bring the sensor element impedance Zac into constant agreement with a target one so that the temperature of the sensor element 10 is kept at a constant value (e.g., 750° C.).

In the impedance measuring mode, the sensor element current Ip is, as described above, swept intentionally, thus causing the A/F output voltage AFO to be unusable for determining the air-fuel ratio of a mixture to the engine. The sequence controller 40, thus, works to prohibit the determination of the air-fuel ratio until expiry of a given period of time after input of the impedance measuring command signal SG1 and output an air-fuel ratio determination enable/inhibit signal SG4 to the microcomputer 200 during another time period which permits the microcomputer 200 to measure the air-fuel ratio of a mixture to the engine.

Ensuring the accuracy of retaining the current change in the current change measuring circuit 32 (i.e., the P/H circuit), as measured in the impedance measuring mode, requires the current change signal Iout to be sampled by the microcomputer 200 within a given sampling period of time completely. In other words, it is necessary for the microcomputer 200 to sample the current change signal Iout completely after the current peak is held correctly by the current change measuring circuit 32, but before changing. This is achieved in this embodiment by determining the time when the microcomputer 200 should sample the current change signal Iout using the air-fuel ratio determination enable/inhibit signal SG4.

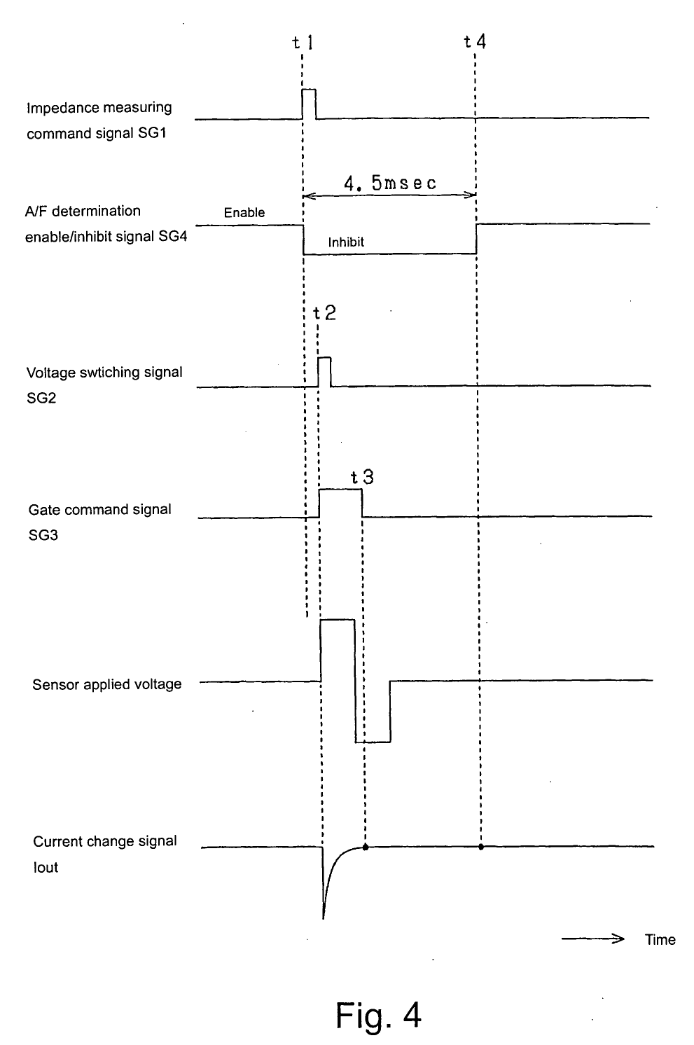

FIG. 4 is a timechart which demonstrates a time-sequential relation among the impedance measuring command signal SG1, the air-fuel ratio determination enable/inhibit signal SG4, the voltage switching signal SG2, the gate command signal SG3, the voltage applied to the sensor element 10, and the current change signal Iout.

In the illustrated example, the microcomputer 200 outputs the impedance measuring command signal SG1 of an on-level in the form of a pulse at time t1 for initiating the measurement of the sensor element impedance Zac. The sequence controller 40 changes the air-fuel ratio determination enable/inhibit signal SG4 outputted to the microcomputer 200 from an enable level to an inhibit level to inhibit the microcomputer 200 from sampling the current change signal Iout. The air-fuel ratio determination enable/inhibit signal SG4 is kept at the inhibit level for a given period of time (e.g., 4.5 sec.) after time t1. This prohibits the microcomputer 200 from determining the air-fuel ratio of a mixture to the engine using the A/F output voltage AFO between time t1 and time t4.

At time t2, the sequence controller 40 outputs the voltage switching signal SG2 of an on-level to the voltage switching circuit 35. The voltage switching signal 35 sweeps the voltage to be applied to the sensor element 10 to the positive and negative sides in sequence. The current change measuring signal 32 measures a change in the sensor element current Ip resulting from the change in the voltage applied to the sensor element 10. The current change measuring signal 32 (i.e., the P/H circuit) is responsive to input of the gate command signal SG3 at time t2 to clear a peak of the sensor element current Ip retained upon a previous change thereof and then holds a peak of the sensor element current Ip occurring upon a current change thereof. At time t3 when the gate command signal SG3 is changed to an off-level, the value of the current peak produced upon the current change in the sensor element current Ip is fixed.

At time t4 when the air-fuel ratio determination enable/inhibit signal SG4 is returned to the enable level, the microcomputer 200 samples the current change signal Iout through the A/D port. When it is between 1 msec. and 10 msec. after the start of change in voltage applied to the sensor element 10, the current change measuring circuit 32 retains the current peak correctly in the P/H circuit. Time t4 is within the above range. The microcomputer 200, thus, samples the current change signal Iout to calculate the sensor element impedance Zac correctly.

As apparent from the above discussion, in the impedance measuring mode, the microcomputer 200 is responsive to the air-fuel ratio determination enable/inhibit signal SG4 outputted from the sequence controller 40 to sample the current change signal Iout without timer counting. This results in decreases in resource such as a timer and operational load of the system.

The microcomputer 200 is, as described above, designed to start to sample the current change signal Iout upon returning of the air-fuel ratio determination enable/inhibit signal SG4 from the inhibit level to the enable level, but may alternatively be designed to perform an A/D conversion at a constant interval and start to sample the current change signal Iout at the time of the A/D conversion immediately following a change in the air-fuel ratio determination enable/inhibit signal SG4 from the enable level to the inhibit level or after n (>2) times of the A/D conversion following a change in the air-fuel ratio determination enable/inhibit signal SG4 from the enable level to the inhibit level.

The air-fuel ratio determination enable/inhibit signal SG4 may be made up of a set of pulses which are to be outputted at a regular interval to the microcomputer 200. The microcomputer 200 may be designed to initiate sampling of the current change signal Iout upon the n^{th} input of edges of the pulses. This facilitates easy of selecting the time when the microcomputer 200 should start to sample the current change signal Iout. In either case, it is essential for the microcomputer 200 to sample the current change signal Iout during a period of time when the current peak held by the current change measuring circuit 32 is useful.

The determination of the sensor element impedance Zac may alternatively be made by supplying the current to the sensor element 10, sweeping it in an ac form, and monitoring a resultant change in voltage provided by the sensor element 10. U.S. Pat. No. 6,578,563 B2, issued Jun. 17, 2003, assigned to the same assignee as that of this application teaches how to determine the sensor element impedance Zac, disclosure of which is incorporated herein by reference.

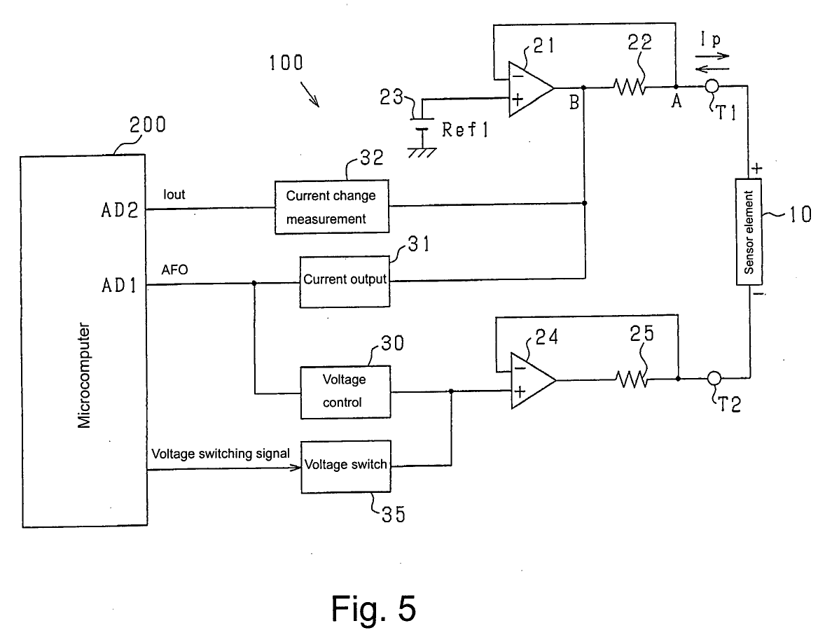

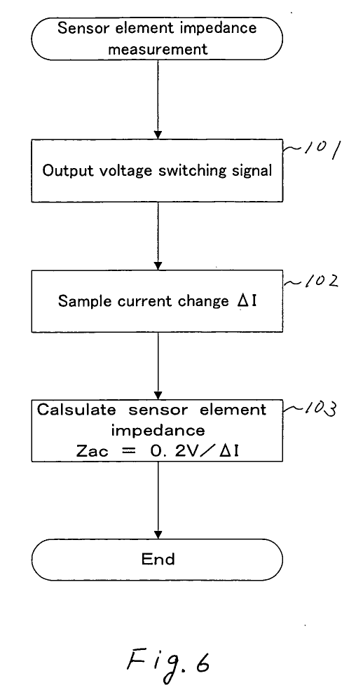

FIG. 5 shows the sensor control circuit 100 according to the second embodiment of the invention which is different from the one of FIG. 1 in that the sequence controller 40 is omitted. The same reference numbers as employed in FIG. 1 will refer to the same parts, and explanation thereof in detail will be omitted here.

When entering the impedance measuring mode, the microcomputer 200 outputs a voltage switching signal to the voltage switching circuit 35. The voltage switching circuit 35 is responsive to the voltage switching signal to sweep level of the voltage to be applied to the sensor element 10 by 0.2V.

The current change measuring circuit 32, like the first embodiment, works to measure and hold the voltage developed at the junction B in the impedance measuring mode and outputs it as the current change signal Iout to the microcomputer 200.

The microcomputer 200 receives the current change signal Iout outputted from the current change measuring circuit 32 through the A/D port AD2, calculates a change ΔI in the sensor element current Ip by dividing the value of the current change signal Iout by a resistance value of the current-measuring resistor 22, and divides a change in the voltage applied to the sensor element 10 by the current change ΔI to determine the sensor element impedance Zac. The change in voltage applied by the voltage switching circuit 30 to the sensor element 10 in the impedance measuring mode is fixed at, for example, 0.2V. The microcomputer 200 stores it in a memory for use in determining the sensor element impedance Zac. In other words, the sensor control circuit 100 is designed not to measure a change in voltage applied to the sensor element 10 each time the impedance measuring mode is entered, but calculate the sensor element impedance Zac using the fixed voltage change retained in the memory of the microcomputer 200.

The voltage switching circuit 35 is subjected to active trimming (also called function trimming), i.e., it is trimmed while functioning to bring an actual change in voltage applied to the sensor element 10 into agreement with a target one (i.e., 0.2V). This results in improved accuracy of controlling the change in voltage applied to the sensor element 10, which permits the amount of change in the sensor element current Ip needed to determine the sensor element impedance Zac to be decreased. This allows the resistance value of the current-measuring resistor 22 to be increased, thus resulting in an increased resolution in determining the air-fuel ratio of a mixture to the engine.

FIG. 6 is a flowchart of a sequence of logical steps or program to be executed by the microcomputer 200 in the impedance measuring mode at a regular interval of, for example, 128 msec.

After entering the program, the routine proceeds to step 101 wherein the voltage switching signal is outputted to the voltage switching circuit 35. The voltage switching circuit 35 is, as described above, responsive to the voltage switching signal to switch the level of the voltage applied to the sensor element 10 for measuring the concentration of gas to that for measuring the sensor element impedance Zac. For instance, the voltage switching circuit 35 changes the voltage applied to the sensor element 10 at 1 kHz to 20 kHz by 0.2V to the positive or negative side. This causes the sensor element current Ip flowing through the sensor element 10 to change, thus resulting in a change in voltage developed at the junction B.

The routine proceeds to step 102 wherein the current change signal Iout produced by the current change measuring circuit 32 is sampled to determine the current change ΔI that is a change in the sensor element current Ip arising from the change in voltage applied to the sensor element 10.

The routine proceeds to step 103 wherein the sensor element impedance Zac is calculated using the current change ΔI, as derived in step 102, and the voltage change ΔV of 0.2V that is the change in voltage applied to the sensor element 10 stored in the memory according to a relation of Zac=0.2/ΔI. The sensor element impedance Zac is, as described above, used for control of the heater 18 of the sensor element 10 or diagnosis of the sensor element 10.

As apparent from the above discussion, the sensor control circuit 100 of this embodiment is designed to calculate the sensor element impedance Zac using the voltage change stored in the memory of the microcomputer 200 and the current change, as measured by monitoring the voltage developed at the junction B. In other words, the sensor control circuit 100 uses the fixed value of the voltage change ΔV and the current change ΔI that is a parameter depending upon electrical characteristics of the sensor element 10 to determine the sensor element impedance Zac, thereby eliminating the need for measuring an actual change in voltage applied to the sensor element 10 in the impedance measuring mode. This eliminates any error in calculating the sensor element impedance Zac arising from an error in measuring the change in voltage applied to the sensor element 10 to improve control of activation of the sensor element 10 and exhaust emissions of the engine or diagnosis of the sensor element 10.

The sensor control circuit 100 is, as described above, not equipped with a measuring circuit for measuring an actual change in the voltage applied to the sensor element 10 in the impedance measuring mode, thus permitting the whole structure of the sensor control circuit 100 to be made of a simple and compact IC chip. In the impedance measuring mode, the microcomputer 200 is required only to A/D convert the current change signal Iout, thus allowing the number of A/D converters used to be decreased.

In a case where inexpensive A/D converters and a reference voltage regulator such as a 5V regulator are used, the structure of the sensor control circuit 100 also works to minimize the error in calculating the sensor element impedance Zac.

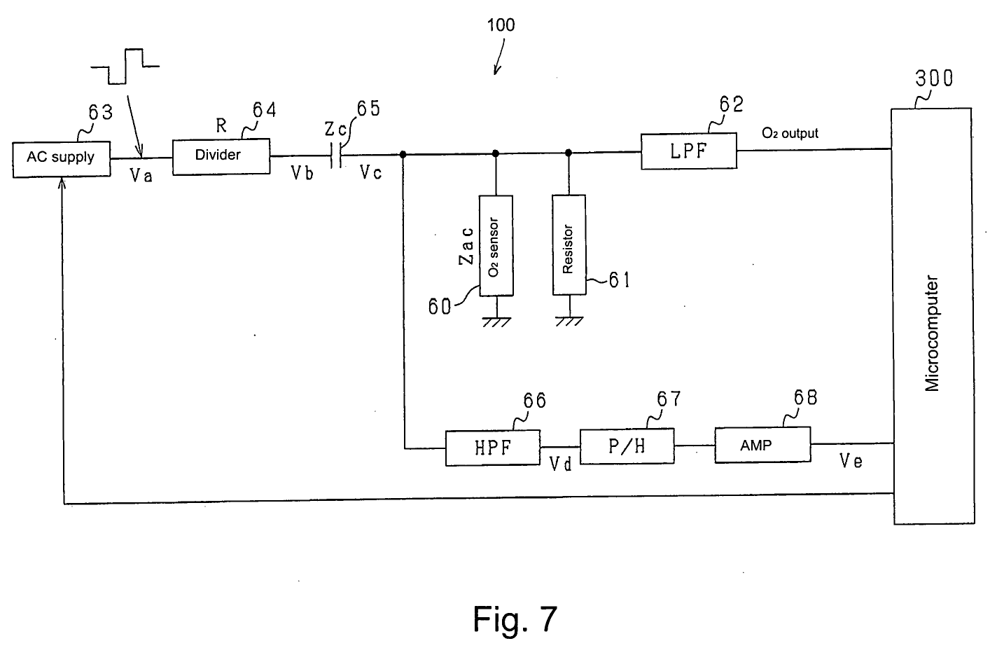

FIG. 7 shows the sensor control circuit 100 according to the third embodiment of the invention which is used with an O₂ sensor 60. The O₂ sensor 60 is of a typical electromotive force type designed to produce an electromotive force between electrodes as a function of concentration of oxygen (O₂) contained in exhaust emissions of the engine. The O₂ sensor 60 is also equipped with a heater to heat a sensor element thereof up to a desired activation temperature.

The sensor control circuit 100 includes a resistor 61, a low-pass filter 62, an ac power supply 63, a voltage divider 64, a coupling capacitor 65, a high-pass filter 66, a peak-and-hold circuit 67, an amplifier 68, and a microcomputer 300.

The resistor 61 and the low-pass filter 62 are connected to one of terminals of the O₂ sensor 60. The O₂ sensor 60 works to produce an electromotive force as a function of concentration of oxygen which is, in turn, outputted to the low-pass filter 62. An output of the low-pass filter 62 is inputted to the microcomputer 300 through an A/D port. The microcomputer 300 uses the output of the O₂ sensor 60 for determining whether the air-fuel ratio of a mixture to the engine is in a rich or a lean state.

The low-pass filter 62 works to remove electrical noises or ac signals added to the output of the O₂ sensor 60 in order to minimize a decrease in accuracy of the output arising from a sweeping change in voltage appearing across the terminals of the O₂ sensor 60 in the impedance measuring mode.

The ac power supply 63, the voltage divider 64, and the coupling capacitor 65 are connected in series with one of the terminals of the O₂ sensor 60. The high-pass filter 66, the peak-and-hold circuit 67, and the amplifier 68 are also connected in series with a junction between the coupling capacitor 65 and the O₂ sensor 60. In the following discussion, the voltage outputted from the ac power supply 63, the voltage appearing at one of terminals of the coupling capacitor 65 leading to the voltage divider 64, the voltage appearing at the other terminal of the coupling capacitor 65 leading to the O₂ sensor 60, the voltage appearing at an output terminal of the high-pass filter 66, and the voltage appearing at an output terminal of the amplifier 68 will be expressed by Va, Vb, Vc, Vd, and Ve below. The voltage Vc is developed by the electromotive force, as produced by the O₂ sensor 60 as a function of the concentration of oxygen in the air-fuel ratio measuring mode. When the exhaust emissions of the engine are in the fuel-rich state, the voltage Vc will be approximately 0.9V. Conversely, when the exhaust emissions are in the fuel-lean state, the voltage Vc will be approximately 0V. The resistance value of the voltage divider 64 will be expressed by R below.

The peak-and-hold circuit 67 is made up of a comparator to which the output of the high-pass filter 66 is inputted and a capacitor connected at one end thereof to an output terminal of the comparator and at the other end to ground and works to hold a peak of the input thereto. The peak-and-hold circuit 67 is also equipped with an internal low-pass filter to remove electrical noises added to the input. For example, in a case where the heater of the O₂ sensor 60 is controlled in PWM (Pulse Width Modulation) manner, the electrical current supplied to the heater through a harness is cut cyclically, thus resulting in a change in magnetic flux produced by a change in the current flowing through the harness which will be transmitted as a noise to a sensor harness usually extending together with the heater harness. The low-pass filter built in the peak-and-hold circuit 67 works to remove such a noise.

The ac power supply 63 is designed to perform substantially the same function as that of the voltage application control circuit 30 of FIG. 1 and works to sweep the level of the voltage Va at a given frequency in response to a command from the microcomputer 300. Such a change in the voltage Va will result in a flow of current through an electric path consisting of the voltage divider 64, the coupling capacitor 65, and the O₂ sensor 60. This causes the voltage Vc that is the voltage appearing at the terminal of the O₂ sensor 60 to change to a fraction of the voltage appearing across the electric path which is given by a ratio of the resistance R of the voltage divider 64 to the sensor element impedance Zac of the sensor element 10. The voltage Vc is then inputted through the high-pass filter 66, the peak-and-hold circuit 67, and the amplifier 68 to the A/D port of the microcomputer 300 as the voltage Ve that is a function of the sensor element impedance Zac.

The microcomputer 300 calculates the sensor element impedance Zac according to an equation below.
Zac=Vc/{(Va−Vc)/R}

The voltage Va and the resistance R of the voltage divider 64 are fixed value and stored in a memory of the microcomputer 300. The determination of the sensor element impedance Zac may, thus, be achieved only by measuring the voltage Vc. Specifically, the microcomputer 300 determines the sensor element impedance Zac using the voltage Vc that is a parameter sampled through the high-pass filter 66, the peak-and-hold circuit 67, and the amplifier 68 and the voltage Va and the resistor R stored in the memory without need for measuring an actual change in voltage applied to the sensor element 10.

The ac power supply 63 is, like the voltage switching circuit 35 of the first embodiment, subjected to the active trimming to bring an actual change in voltage applied to the sensor element 10 into agreement with a target one (i.e., 0.2V).

The frequency at which the ac power supply 63 sweeps the voltage Va in the impedance measuring mode is approximately 10 kHz. The resistance R of the voltage divider 64 is of the order of 1 kΩ. The capacitance of the coupling capacitor 65 is preferably 0.1 to 1 μF in terms of effects on the output of the O₂ sensor 60 and more preferably less than 0.2 μF in terms of costs or size thereof. It is advisable that a greater value of the capacitance be desirable for measuring the sensor element impedance Zac. In this embodiment, the capacitance of the coupling capacitor 65 is 0.1 μF. The capacitance of the O₂ sensor 60 is usually of the order of 1000 μF in mint condition and 100 μF in aged condition either of which is much greater than that of the coupling capacitor 65.

In the impedance measuring mode, the voltage Vc that is the voltage appearing at the terminal of the O₂ sensor 60 has a peak bearing a correlation to the sensor element impedance Zac and is insensitive to the capacitance of the O₂ sensor 60 in the course of convergence thereof, which ensures the accuracy of measuring the sensor element impedance Zac. Particularly, the coupling capacitor 65 is, as described above, much smaller in capacitance than the O₂ sensor 60, so that the convergence of the voltage Vc depends greatly upon the speed at which the coupling capacitor 65 is charged. The voltage Vc is, therefore, insensitive to an individual variability or unit-to-unit variation in the O₂ sensor 60 or aging thereof, thereby keeping the accuracy of determining the sensor element impedance Zac free from such variable factors.

The sensor control circuit 100, as described above, works to determine the sensor element impedance Zac using the voltage change ΔV stored in the memory and a measured value of the current change ΔI, but may alternatively be designed to use the measure value of the current change ΔI as a parameter for controlling the heater of the sensor element 10 or the O₂ sensor 60 or diagnosis thereof. Specifically, the voltage change ΔV is a fixed value, so that the sensor element impedance Zac is in inverse proportion to the current change ΔI, and the admittance of the sensor element 10 is proportional to the current change ΔI. The sensor control circuit 100 may, thus, use a measured value of the current change ΔI directly to control the heater of the sensor element 10 or the O₂ sensor 60 or diagnosis thereof.

The sensor control circuit 100 may use the admittance of the sensor element 10 or the O₂ sensor 60 that is an inverse of the sensor element impedance Zac as a parameter for controlling the heater of the sensor element 10 or the O₂ sensor 60 or diagnosis thereof instead of the sensor element impedance Zac (i.e., admittance=ΔI/0.2V).

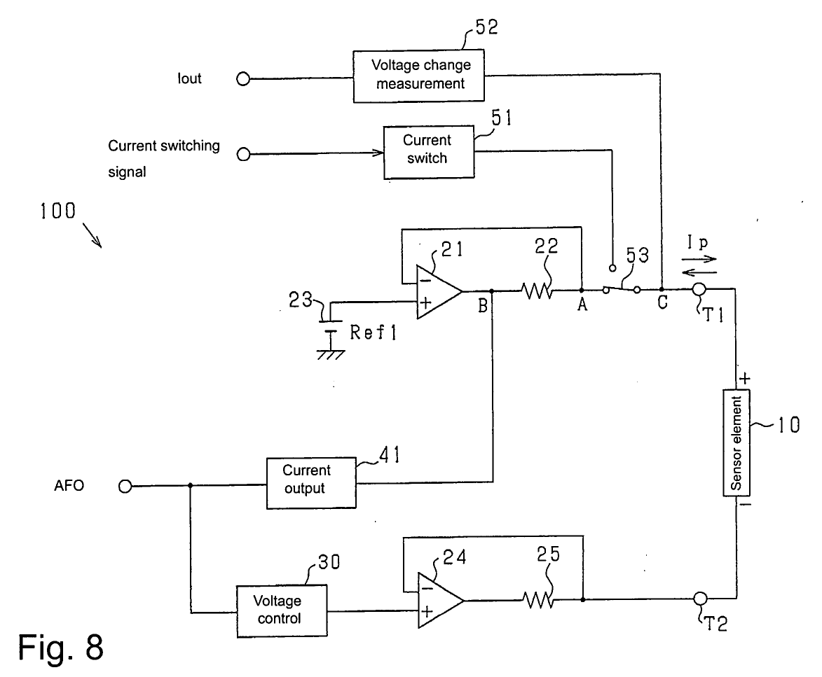

FIG. 8 shows a sensor control circuit 100 according to the fourth embodiment of the invention which is designed to change the current flowing through the sensor element 10 in the ac form and measure a resultant change in voltage appearing at one of the terminals of the sensor element 10 to determine the sensor element impedance Zac. The same reference numbers as employed in FIG. 1 will refer to the same parts, and explanation thereof in detail will be omitted here.

The sensor control circuit 100 includes a current switching circuit 51, a voltage change measuring circuit 52, a switch 53, and a sensor element current output circuit 41. The switch 53 is joined to the positive terminal T1 of the sensor element 10. The current-measuring resistor 22 is jointed to one of contacts of the switch 53. The current switching circuit 51 is jointed to the other contact of the switch 53. In the impedance measuring mode, the switch 53 makes a connection of the current switching circuit 51 to the positive terminal T1. The current switching circuit 51 works to sweep the current flowing through the sensor element 10 in response to a current switching signal outputted from the microcomputer 200 (not shown in the drawing) like the one as illustrated in FIG. 1 or 5. The voltage change measuring circuit 52 is connected to a junction C between the switch 53 and the positive terminal T1 and works to monitor the voltage appearing at the junction C and output a voltage change signal that is a function of the sensor element impedance Zac to the microcomputer 200. The current switching circuit 51 may be subjected to the active trimming to adjust dynamic electrical characteristics thereof to desired ones.

The microcomputer 200 stores in an internal memory thereof an amount by which the current flowing through the sensor element 10 is to be changed by the current switching circuit 51 to measure the sensor element impedance Zac and works to sample an actual value of the voltage change ΔV through the voltage change signal outputted from the voltage change measuring circuit 52 to calculate the sensor element impedance Zac using the current change stored and the sampled value of the voltage change ΔV. In other words, the sensor control circuit 100 uses the fixed amount by which the current flowing through the sensor element 10 is to be changed and a measured value of the voltage change ΔV that is a parameter depending upon electrical characteristics of the sensor element 10 to determine the sensor element impedance Zac, thereby eliminating the need for measuring an actual change in current flowing through the sensor element 10. This minimizes any error in calculating the sensor element impedance Zac arising from an error in measuring the change in current flowing through the sensor element 10 to improve control of activity of the sensor element 10 and exhaust emissions of the engine or diagnosis of the sensor element 10.

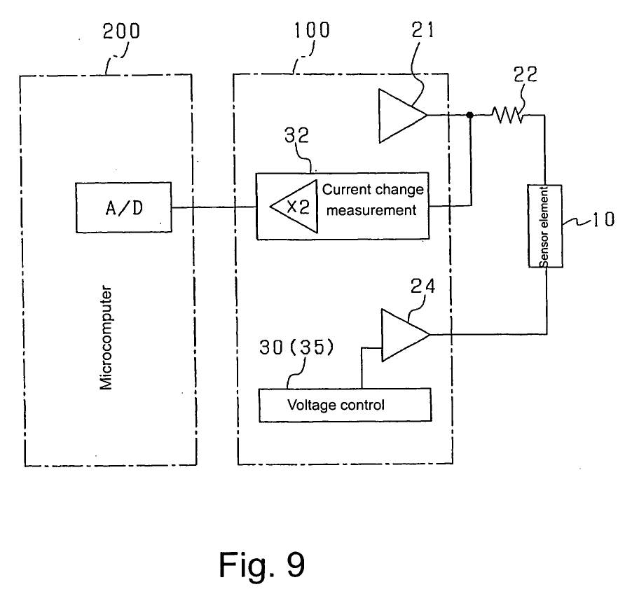

The sensor control circuit 100 of the second embodiment, as illustrated in FIG. 5, may also have an amplifier connected to the output of the current change measuring circuit 32. FIG. 9 shows an example of such a structure. The current change measuring circuit 32 is equipped with an amplifier having an amplification factor β of two (2). An resistor of the amplifier may be trimmed to adjust the amplification factor β so as to absorb an error in the current change signal Iout arising from an error in controlling the voltage applied to the sensor element 10.

The sensor control circuit 100 in each of the first to fourth embodiments may alternatively be used with a gas sensor equipped with a laminate of a plurality of solid electrolyte layers or a cup-shaped sensor element.

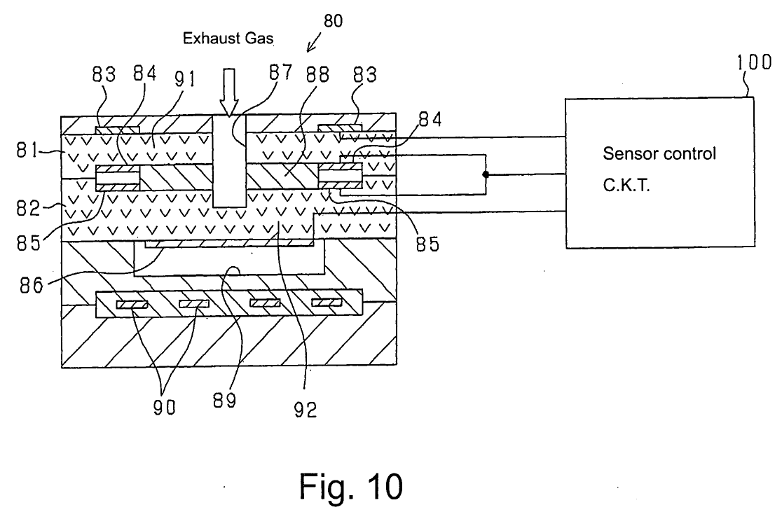

FIG. 10 shows a sensor element 80 which may be employed in each of the first to fourth embodiments.

The sensor element 80 includes a laminate of two solid electrolyte layers 81 and 82. The solid electrolyte layer 81 has electrodes 83 and 84 affixed to opposed surfaces thereof. Similarly, the solid electrolyte layer 82 has electrodes 85 and 86 affixed to opposed surfaces thereof. Each of the electrodes 83, 84, and 85 is viewed in the drawing as being made up of right and left separate parts, but, it is, in practice, formed by a single plate having a connecting portion (not shown) extending in a transverse direction in the drawing.

The solid electrolyte layer 81 and the electrodes 83 and 84 constitute a pump cell 91. The solid electrolyte layer 82 and the electrodes 85 and 66 constitute an oxygen sensor cell 92. The electrodes 83 to 86 are joined to the sensor control circuit 100 which leads to the microcomputer 200 illustrated in FIG. 1 or 5 or the microcomputer 300 in FIG. 7.

The sensor element 80 also includes a gas inlet 87 through which exhaust gasses of the automotive engine enter and a porous diffusion layer 88, an air duct 89, and a heater 90. The structure and operation of this type of sensor element are disclosed in, for example, U.S. Pat. No. 6,295,862 B1, assigned to the same assignee as that of this application, disclosure of which is incorporated herein by reference. The oxygen senor cell 92 is generally also called an electromotive force cell or an oxygen concentration sensor cell.

The oxygen sensor cell 92 works to produce an electromotive force which has one of two discrete values (e.g., 0V and 0.9V) selectively as a function of whether the exhaust gasses are on the rich side or the lean side of a stoichiometric point corresponding to a stoichiometric air-fuel ratio of mixture supplied to the engine. When the exhaust gasses are on the lean side, the oxygen sensor cell 92 produces a lower electromotive force. Conversely, when the exhaust gasses are on the rich side, the oxygen sensor cell 92 produces a higher electromotive force. The sensor control circuit 100 works to control the voltage applied to the pump cell 91 so that an electromotive force produced by the oxygen sensor cell 92 is kept at 0.45V which corresponds to the stoichiometric point.

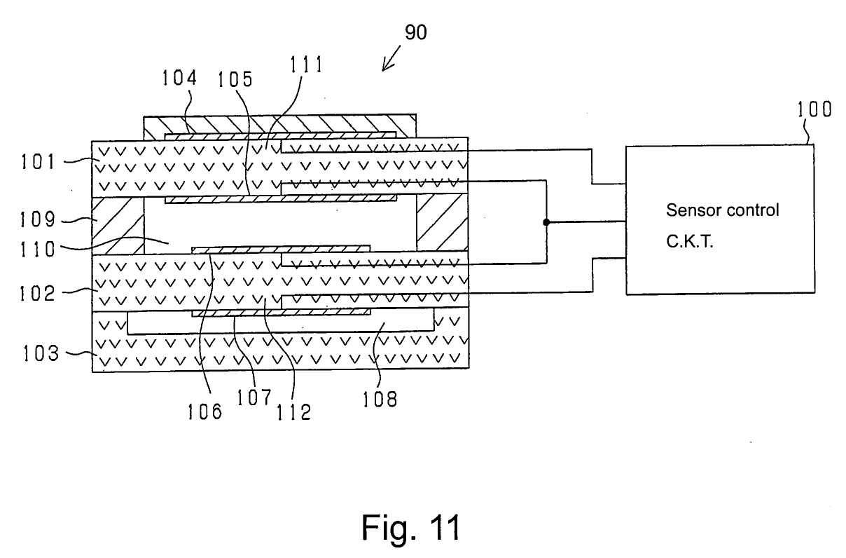

FIG. 11 shows a sensor element 90 which may be used in each of the first to fourth embodiments.

The sensor element 100 includes three solid electrolyte layers 101, 102, and 103. The solid electrolyte layer 101 has electrodes 104 and 105 affixed to opposed surfaces thereof. Similarly, the solid electrolyte layer 102 has electrodes 106 and 107 affixed to opposed surfaces thereof. The solid electrolyte layer 101 and the electrodes 104 and 105 form a pump cell 111. The solid electrolyte layer 102 and the electrodes 106 and 107 form an oxygen sensor cell 112. The solid electrolyte layer 103 forms a wall defining an oxygen reference chamber 108. The sensor element 90 also includes a porous diffusion layer 109 and a gas chamber 110 into which exhaust gasses of the automotive engine enter. The oxygen sensor cell 112 operates, like the oxygen sensor cell 92 illustrated in FIG. 10, as an electromotive force cell or an oxygen concentration sensor cell.

The gas concentration measuring apparatus, as described in each of the above embodiments, may be used with a composite gas concentration measuring sensor which includes first and second cells made of a solid electrolyte body. The first cell works as a pump cell to pump oxygen molecules out of or into a first gas chamber formed in a sensor body and output a signal indicative of the concentration of the pumped oxygen molecules. The second cell works as a sensor cell to produce a signal indicative of the concentration of a preselected component of gasses flowing into a second gas chamber from the first gas chamber. For example, the composite gas concentration measuring sensor may be used to measure the concentration NOx contained in exhaust gasses of the automotive engine. The sensor control circuit 100 preferably works to measure the resistance (i.e., the impedance or admittance) of either of the first or second cell.

Further, the composite gas concentration measuring sensor may be designed to have a third cell serving as a monitor cell or a second pump cell to produce an electromotive force as a function of concentration of oxygen molecules remaining in the second gas chamber.

The gas concentration measuring apparatus may alternatively be designed to measure the concentration of HC or CO contained in the exhaust gasses of the automotive engine. The measurement of concentration of HC or CO is achieved by pumping excessive oxygen (O₂) out of the first gas chamber using the pump cell and decomposing HC or CO contained in the gasses entering the second gas chamber using the sensor cell to produce an electric signal indicative of the concentration of HC or CO.

The A/F sensor used in the above embodiments may alternatively be designed to develop an electromotive force between the electrodes of the sensor element as a function of concentration of NOx or CO containing an oxygen component. Specifically, one of the electrodes works to ionize NOx or CO to produce oxygen ions. When a difference in oxygen partial pressure between sides of the solid electrolyte body is created, it will cause the electromotive force to be produced as a function of such a difference according to the Nernst's equation.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas concentration measuring apparatus comprising:
a sensor circuit connected to a gas sensor element equipped with a solid electrolyte, said sensor circuit working to measure an output of the gas sensor element produced as a function of concentration of a gas and output a signal indicative of the measured output; and
an arithmetic circuit working to analyze the signal outputted from said sensor circuit to determine a concentration of the gas, said arithmetic circuit outputting a first command signal cyclically,
wherein said sensor circuit is responsive to an input of the first command signal from said sensor circuit to output a second command signal for a given period of time and to subject the gas sensor element to a given amount of change in one of voltage applied thereto and current flowing therethrough, said sensor circuit measuring and retaining a resulting change in one of current flowing through said gas sensor element and voltage developed at said gas sensor element, and
wherein said arithmetic circuit is responsive to input of the second command signal from said sensor circuit to determine a sampling time, when the sampling time is reached, said arithmetic circuit starting to sample the resulting change out of said sensor circuit and calculating a resistance of said gas sensor element based on the sampled resulting change.

2. A gas concentration measuring apparatus as set forth in claim 1, wherein the second command signal outputted by said sensor circuit works as an inhibit signal to inhibit said arithmetic circuit from analyzing the signal outputted from said sensor circuit to determine the concentration of the gas for the given period of time.

3. A gas concentration measuring apparatus as set forth in claim 2, wherein the inhibit signal is switched between an inhibit level to inhibit determination of the concentration of the gas and an enable level to permit the determination of the concentration of the gas, upon switching of the inhibit signal from the inhibit level to the enable level, said arithmetic circuit starts to sample the resulting change out of said sensor circuit.

4. A gas concentration measuring apparatus as set forth in claim 1, wherein the second command signal is made up of a set of pulses, and wherein said arithmetic circuit determines the sampling time based on input of one of the pulses.

5. A gas concentration measuring apparatus comprising:
a sensor circuit designed to apply a voltage to a gas sensor element equipped with a solid electrolyte and measure a resulting flow of current through the gas sensor element to determine a concentration of a gas based on the measured current, when a resistance measuring mode is entered, said sensor circuit working to create a change in one of voltage and current in an electric line leading to the gas sensor element and sample a resulting change in one of current flowing through said gas sensor element and voltage developed at said gas sensor element; and
an arithmetic circuit working to use only the sampled resulting change in the one of current and voltage as a variable parameter to determine a resistance of the gas sensor element.

6. A gas concentration measuring apparatus as set forth in claim 5, wherein said arithmetic circuit stores the change in one of voltage and current to be created in the electric line leading to the gas sensor element as a fixed value and determines the resistance of the gas sensor element based on the fixed value and the sampled resulting change in the one of current and voltage.

7. A gas concentration measuring apparatus as set forth in claim 5, wherein said sensor circuit also works to amplitude the sampled resulting change in the one of current and voltage to produce a sensor response signal, and wherein said arithmetic circuit is implemented by a microcomputer which works to A/D convert the sensor response signal to determine the resistance of the gas sensor element.

8. A gas concentration measuring apparatus as set forth in claim 5, wherein said sensor circuit includes a circuit component working to subject the gas sensor element to the given amount of change in one of voltage applied thereto and current flowing therethrough, said circuit component being trimmed to adjust an electric characteristic thereof so as to bring the given amount of change in the one of voltage and current into agreement with a desired one.

9. A gas concentration measuring apparatus comprising:
a gas sensor element equipped with a pair of electrodes and a solid electrolyte interposed between the electrodes, said gas sensor element working to produce an electromotive force as a function of concentration of one of oxygen contained in gases and a specified component of the gases which contains an oxygen component;
an electric change creating circuit working to create a change in one of voltage and current in an electric line leading to said gas sensor element;
a series circuit made up of a resistor and a capacitor joined in series, said series circuit being connected between said electric change creating circuit and said gas sensor element;
a voltage measuring circuit working to measure a voltage developed at a terminal of said gas sensor element; and
an arithmetic circuit working to use only a value of the voltage measured by said voltage measuring circuit which results from the change in the one of voltage and current created by said electric change creating circuit as a variable parameter to determine a resistance of the gas sensor element.

10. A gas concentration measuring apparatus as set forth in claim 9, wherein said arithmetic circuit stores the change in one of voltage and current to be created in the electric line leading to the gas sensor element as a fixed value and determines the resistance of the gas sensor element based on the fixed value and the measured value of the voltage.

11. A gas concentration measuring apparatus as set forth in claim 9, wherein said voltage measuring circuit also works to amplitude and output the voltage developed at the terminal of said gas sensor element as a sensor response signal, and wherein said arithmetic circuit is implemented by a microcomputer which works to A/D convert the sensor response signal to determine the resistance of the gas sensor element.

12. A gas concentration measuring apparatus as set forth in claim 9, wherein said electric change creating circuit is trimmed to adjust an electric characteristic thereof so as to bring the change in the one of voltage and current to be created into agreement with a desired one.
